(19) United States
(12) Patent Application Publication
(10) Pub. No.: US 2004/0139430 A1
(43) Pub. Date: Jul. 15, 2004

(54) MULTIVENDOR PACKAGE MANAGEMENT

(76) Inventors: David A. Eatough, Provo, UT (US); Jeffrey C. Compas, Lehi, UT (US); Travis M. Stockwell, Riverton, UT (US)

Correspondence Address: FISH & RICHARDSON, PC, 12390 EL CAMINO REAL, SAN DIEGO, CA, 92130-2081, US

(21) Appl. No.: 09/741,986

(22) Filed: Dec. 20, 2000

(51) Int. Cl. G06F 9/44

(52) U.S. Cl. 717/174

(57) ABSTRACT

A software management system is disclosed. The system includes a vendor package template, a package importer, and a package agent. The vendor package template provides a script to install, upgrade, and remove at least one software package. The package importer receives the software package, and creates a package document (X-package) based on the vendor package template. The package agent receives, deploys and executes the X-package at a target computer.

### BACKGROUND

This invention relates to software package management, and more particularly to management of software packages involving multiple vendor software.

Easy and reliable distribution, installation and maintenance of software programs for use in computer systems are desirable. When computer systems were relatively large and isolated, a human technician would travel to the computer system and install the appropriate programs and/or components necessary for the local operation on the computer system. Upon release of the update to the software program, a technician would again travel to the computer system and apply the update. The proliferation of computer workstations and personal computers has rendered this method of distribution, installation and maintenance undesirable.

As technology has improved, it has become commonplace for the producers of software programs to distribute their products on high-capacity media such as diskettes, or compact discs (CD). The software programs often comprise a collection of independent modules that provide different functionality or serve to tailor the software program to a particular environment. By combining these modules in a particular manner, a tailored software program is assembled on the end user computer system that is generally specific to that system and the end user's requirements.

Unfortunately, many end users of software programs lack either the technical ability or desire or both to substantially contribute to the installation of a complex software program. As a result, the producers of the software programs have provided their products with installation programs that automate the software installation process sufficiently to permit an end-user to perform the installation.

The components or modules associated with an installation are frequently distributed as compressed or encrypted (or both) files. Such compressed/encrypted components are often combined together in a package, i.e., as a single “self-extracting” executable program. When such a self-extracting program is run, it un-packages all of the components and de-crypts and decompresses them as appropriate.

However, the existing software distribution processes lack solutions for supporting multiple vendor software and multiple operating system environment.

### DESCRIPTION OF DRAWINGS

These and other features and advantages of the invention will become more apparent upon reading the following detailed description and upon reference to the accompanying drawings.

FIG. 1 illustrates a Multiple Vendor Package Management (MVPM) system according to an embodiment of the present disclosure.

FIG. 2 illustrates a process of distributing vendor-specific software to target computers.

### DETAILED DESCRIPTION

In the present disclosure, a package is defined as a set of one or more files that contain substantial number of logic and binaries necessary to install an application. Currently, there are many vendors that provide package-building technologies, such as LANDesk Management Suite (LDMS), Red Hat Package Manager (RPM), Microsoft Windows Installer (MSI), 20/20, or other similar programs. However, in order to make a package manageable in a system, the package must be imported into the system.

The present disclosure describes a Multiple Vendor Package Management (MVPM) system, which provides a means for managing packages from different vendors. The management means may also include elements for managing different operating systems, in a uniform and consistent manner. Furthermore, the MVPM system provides a means for importing the package into the system.

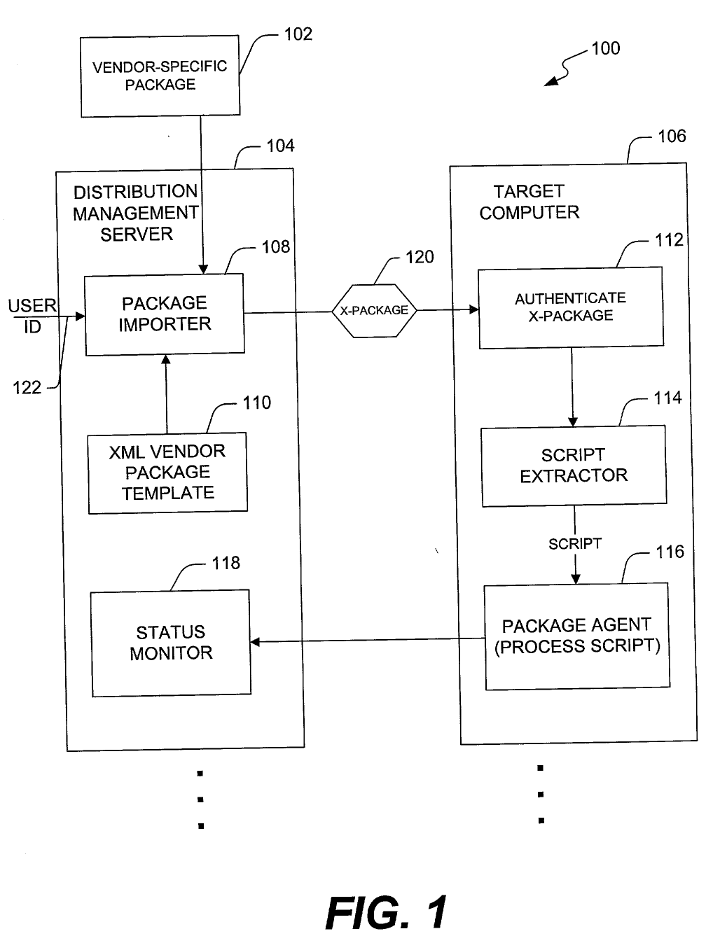

FIG. 1 illustrates an MVPM system 100 according to an embodiment of the present disclosure. The MVPM system 100 may include a distribution management server 104 in which a package containing software to be distributed is built. The system 100 may further include target computers 106 that represent intended destinations for the software.

In the illustrated embodiment of FIG. 1, a vendor-specific software package 102 is imported into the system 100 by a package importer 108. The package importer 108 receives the vendor-specific software package 102 and creates a new package document referred to as an X-package 120. In one embodiment, the X-package 120 may include an Extensible Markup Language (XML) package document. However, the X-package 120 may include any other package documents capable of packing vendor-specific software. The package importer 108 creates the X-package 120 based on an XML vendor package template (XVPT) 110. The XVPT 110 may include a script template that installs, upgrades, and removes the package 102.

The package importer 108 may then verify the identity (ID) of the user by checking the user ID 122 against an access control list. The authorized user selects the file(s) of the software package 102, and if necessary identifies the package vendor and provides additional attributes. As part of the X-package 120 creation process the user performing the import is recorded and the X-package 120 is signed.

The X-package 120 may include a uniformly consistent set of attributes that allows the attributes to be displayed in a substantially similar manner regardless of the package vendor. Furthermore, the consistency allows all X-packages 120 to be managed in a single user interface.

The X-package 120 may also include a script that may install the specific package. The script may contain the logic for interacting with the vendor-specific package agents. Further, the script may be supported on multiple operating systems. For example, a software program called Perl may provide the necessary platform to interpret the script for various operating systems, including Unix, Linux, Windows, and Macintosh. The X-package 120 may further include the name or ID of the user who imported the package, cyclic redundancy check (CRC) or hash of all package files, and/or a digital signature of the X-package contents.

Once the X-package 120 is created and attributed, the X-package 120 may be transferred to the target computer 106 for distribution. The transfer may be accomplished using either push or pull distribution. The push distribution is administrator initiated, and may run automatically at a scheduled time from a distribution management server 104. An end user at the target computer 106 may choose to receive the distribution or reject it.

The pull distribution is end-user initiated. This distribution may be used by end-users who often disconnect their computer from the network. After a pull distribution is scheduled, the X-package 120 may be visible on the distribution management server 104, indicating that the package 120 is available. The end-user may decide when to pull the package to the target computer 106, if at all.

The software distribution task may be accomplished by having an authentication element 112 in the target computer 106 authenticate the X-package 120 signature. The authentication element 112 validates the digital signature in the X-package 120 with a list of certificates trusted by the target computer 106. When the X-package 120 has been authenticated, a script extractor 114 extracts the X-package script.

The script is then sent to a package agent 116 for processing and execution. The script handles all vendor specific issues. The package agent 116 performs the deployment and execution of X-packages 120 in a consistent manner. The package agent 116 checks the operating system, downloads any needed files, and reports any intermediate status of the software distribution task. The status may include files downloaded, installation started, and so on. The status is reported to a status monitor 118 in the distribution management server 104.

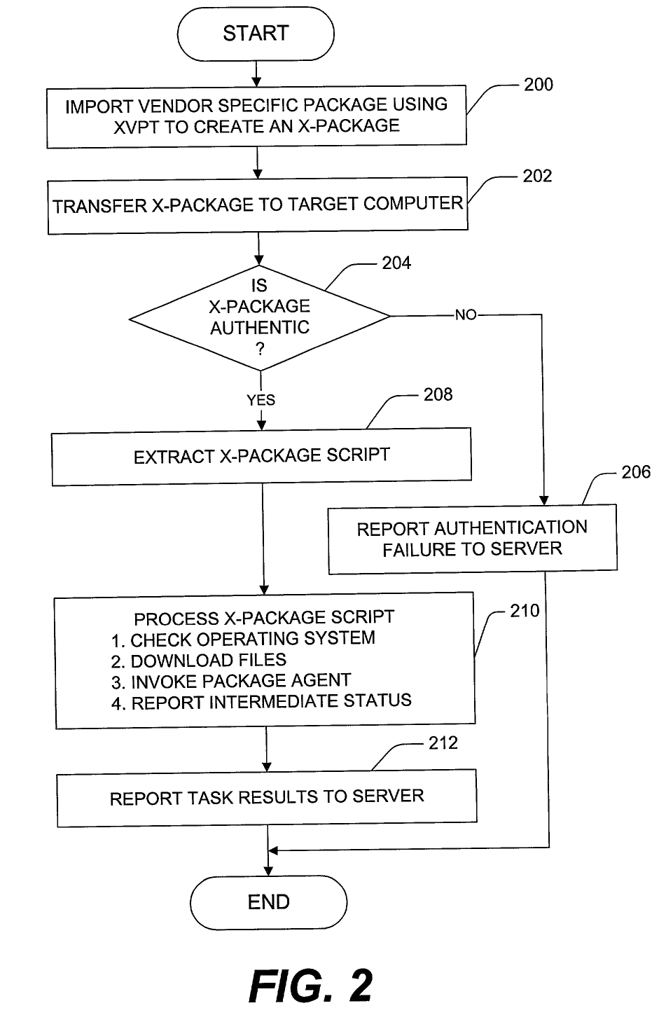

FIG. 2 illustrates a process of distributing vendor-specific software to target computers. The process includes importing a vendor-specific software package 102 using an XML vendor package template 110 at 200. In the process of importing a vendor-specific package 102, an XML package document (X-package) 120 is created. The X-package 120 is transferred to a target computer 106 at 202. The X-package 120 is then authenticated, at 204, to determine if the X-package is valid. If the X-package 120 is not authenticated, the failure is reported to a distribution management server 104 at 206. Otherwise, the authenticated X-package script is extracted at 208.

The X-package script is processed and executed at 210. The X-package script involves checking the operating system, downloading the files, invoking package agent, and reporting the intermediate status. Once the software distribution is completed, the task result is reported to the distribution management server 104 at 212.

The MVPM system 100 of the present disclosure offers advantageous features over the existing software distribution solution. The advantageous features include security, ease of use, and support for multiple operating systems.

The MVPM system 100 offers security advantage over the existing solution by controlling the process of importing the vendor-specific packages. The added security offered by the package importer 108 prevents malicious packages from being added to the system 100. However, existing solutions offered by software management systems, such as LANDesk Management Suite (LDMS), fail to provide adequate protection from malicious incorporation. Further, since the X-packages are signed and hashed, the packages may be authenticated at the target computer. The authentication process may involve verifying the package by checking the source of the package. The package may be authenticated if the source is lined to a reliable source list in the target computer. The process may also involve verifying that the X-package and the associated package files have not be modified.

The MVPM system 100 also offers advantages of ease of use because the system 100 provides the ability to manage packages from multiple package vendors using a single consistent interface. Changing package vendors, for example from LDMS to 20/20, is easier for the MVPM system 100 than the existing software management system. The MVPM system 100 allows the user to manage both types of packages using the same system. Furthermore, this may mean that the old packages may still be used while transitioning to the new package vendor. The existing systems often require learning a new interface or packaging all application with the new vendor before changing the package vendor. By using one consistent interface for all package formats and operating systems, the user does not have to learn multiple interfaces and methods for managing packages.

The MVPM system 100 further offers capability to support multiple operating systems. Since the X-packages are designed to use a script that is supported on multiple operating systems, scripts may be processed on multiple operating systems. The X-package script is the only component that needs to deal with operating system specific issues.

While specific embodiments of the invention have been illustrated and described, other embodiments and variations are possible. For example, although the illustrated embodiment shows only one server 104 and one target computer 106 for ease of understanding, it should be understood that the MVPM system 100 may include other servers and target computers.

All these are intended to be encompassed by the following claims.

What is claimed is:

1. A software management system, comprising:
a vendor package template that provides a script to install, upgrade, and remove at least one software package;
a package importer to receive said at least one software package, where said package importer creates an X-package document based on said vendor package template; and
a package agent to receive, deploy and execute said X-package at a target computer.

2. The software management system of claim 1, wherein said package importer receives a user identity for recording.

3. The software management system of claim 1, wherein said X-package includes a substantially uniform set of attributes that allows said at least one software packages to be managed in a single user interface.

4. The software management system of claim 3, wherein said X-package includes a substantially uniform set of attributes that allows said at least one software packages to be managed in a single user interface.

5. The software management system of claim 1, wherein said package importer tags said X-package with a signature.

6. The software management system of claim 5, further comprising:
an authentication element to provide verification of the X-package by validating the signature in the X-package with a list of certificates trusted by the target computer.

7. The software management system of claim 6, further comprising:
a script extractor to extract an X-package script.

8. The software management system of claim 7, wherein said X-package script includes logic for interacting with a vendor-specific package agent.

9. The software management system of claim 7, wherein said X-package script includes logic for interacting with multiple operating systems.

10. The software management system of claim 1, wherein said X-package further includes a name of a user who imported said at least one software package.

11. The software management system of claim 1, wherein said X-package further includes hash of package files included in said at least one software package.

12. The software management system of claim 1, wherein said package agent checks relevant operating system of said at least one software package.

13. The software management system of claim 1, wherein said package agent downloads any needed files.

14. The software management system of claim 1, wherein said package agent reports status.

15. A software management system, comprising:
a distribution management server including:
a vendor package template that provides a script to install, upgrade, and remove at least one software package; and
a package importer to receive said at least one software package, said package importer creates an X-package document based on said vendor package template, where said package importer tags said X-package with a signature;
a plurality of target computers, each target computer including:
an authentication element to provide verification of the X-package by validating the signature in the X- package with a list of certificates trusted by the target computer;
a script extractor to extract an X-package script; and
a package agent to receive, deploy and execute said X-package at the target computer.

16. The software management system of claim 15, wherein said at least one software package includes packages from different vendors.

17. The software management system of claim 16, wherein said X-package includes a substantially uniform set of attributes that allows said at least one software packages to be managed in a single user interface.

18. A method for distributing vendor-specific software to target computers, comprising:
importing the vendor-specific software using a vendor package template to create an X-package having a script;
transferring said X-package to target computers; and
processing said X-package script.

19. The method of claim 18, further comprising:
authenticating the X-package by validating a signature on said X-package.

20. The method of claim 18, further comprising:
extracting the script from said X-package for processing.

21. The method of claim 18, wherein said processing said X-package script includes checking a relevant operating system of the vendor-specific software.

22. The method of claim 18, wherein said processing said X-package script includes downloading all relevant files.

23. The method of claim 18, wherein said processing said X-package script includes reporting status.

24. An apparatus comprising a machine-readable storage medium having executable instructions that enable the machine to:
import the vendor-specific software using a vendor package template to create an X-package having a script;
transfer said X-package to target computers; and
process said X-package script.

25. The apparatus of claim 24, further comprising:
authenticate the X-package by validating a signature on said X-package.

26. The apparatus of claim 24, further comprising:
extract the script from said X-package for processing.
